(19) United States
(12) Patent Application Publication
(10) Pub. No.: US 2018/0346706 A1
(43) Pub. Date: Dec. 6, 2018

(54) Heat Curable Sealant for Fuel Cells

(71) Applicant: Henkel IP & Holding GmbH, Duesseldorf (DE)

(72) Inventors: Shuhua Jin, Cheshire, CT (US); Alfred A. DeCato, Highland, MI (US)

(21) Appl. No.: 16/100,550

(22) Filed: Aug. 10, 2018

Related U.S. Application Data
(63) Continuation of application No. PCT/US2017/017311, filed on Feb. 10, 2017.
(60) Provisional application No. 62/293,892, filed on Feb. 11, 2016.

(51) Int. Cl. C08L 33/10; C08L 47/00; C08K 5/14; C08K 3/36; C08K 9/06; H01M 2/08

(52) U.S. Cl. CPC C08L 33/10; C08L 47/00; C08K 5/14; C08F 2/48; C08K 9/06; H01M 2/08; C08L 2203/20; C08K 3/36

(57) ABSTRACT

Disclosed is a heat curable composition that cures to an elastomer. The composition finds special use as an injection moldable sealant, especially for fuel cells. The composition includes at least one (meth)acrylate terminated polyolefin; at least one ester (meth)acrylate monomer comprising a C₁ to C₃₀ ester; at least one free radical heat cure initiator; at least one silica filler; and optionally, one or more additives. The composition provides for rapid cure rates on the order of several minutes allowing for mass production. In addition, the formulation viscosity is sufficiently low enough to permit use in a wide variety of injection mold processes.

### TECHNICAL FIELD

This invention relates generally to heat curable elastomeric sealant materials and more particularly to a heat curable elastomeric sealant for use in a fuel cell environment.

### BACKGROUND OF THE INVENTION

Elastomeric compositions are often used as sealing material, gasket material, adhesives and for the making of molded flexible parts. Elastomeric compositions exhibit viscoelasticity, meaning they have both viscosity and elasticity, and very weak inter-molecular forces, generally having low Young's modulus and high failure strain compared with other materials. Elastomeric compositions often contain at least one elastomeric or rubber polymer, a filler material, and a crosslinking component. Elastomeric polymers are amorphous polymers existing above their glass transition temperature, so that considerable segmental motion is possible. At ambient temperatures, elastomers are thus relatively soft and deformable. The long polymer chains of the elastomer are crosslinked during curing, which can include vulcanizing. The elasticity is derived from the ability of the long polymeric chains to reconfigure themselves to distribute an applied stress. The covalent crosslinkages between polymer chains ensure that the elastomer will return to its original configuration when the stress is removed. As a result of this extreme flexibility, elastomers can be repeatedly extended at least 200% from their initial size without permanent deformation, depending on the specific material. Without the crosslinkages or with short, uneasily reconfigured chains, the applied stress, would result in a permanent deformation. As discussed elastomeric compositions find special use in sealable compositions and components such as gasket materials. They are used in all sorts of gaskets including in fuel cells, engine component sealing, water tight seals and other sealing applications.

Elastomeric compositions designed to be cured using ultraviolet light, visible light, or actinic radiation curing methods are known. These curing methods are useful when the light or radiation has access to the uncured sealant material; however they are not useful for situations such as injection molding the sealant with molds that do not permit penetration to light or electromagnetic radiation.

Elastomeric compositions designed to be cured by heating are known. Heat curing of molded elastomeric compositions suffers from conflicting requirements. Low viscosity and a slow cure rate are desirable to allow the uncured composition to be injected into an intricately shaped mold without premature curing of that composition before the mold has been completely filled. A slow curing rate also provides long shelf-stability or time during which the curable composition can be shipped and stored before use. However, fast curing is desirable to minimize molding process time. Thus, heat curable compositions are a compromise of viscosity, cure speed and uncured composition stability.

Prior art solutions have included UV/Visible light cure polymers containing polyolefin backbones with acrylate functional groups on them. These have the advantage of being fast to cure and controllable; however they require access to a light source for curing and often have viscosities that are too high for liquid injection molding. There are heat curable silicone based rubbers, composed of a backbone of silicon, oxygen, carbon and hydrogen that have good elastomeric properties such as compression set and mechanical properties; however they tend to have very high moisture and gas permeability which is not desired in the present disclosure. Likewise heat curable sealants based on ethylene propylene diene monomer (EPDM) terpolymer rubber or alkenyl terminated polyisobutylene/silicone hydride addition cured rubber are also not satisfactory. The heat cured EPDM rubbers have too high of a viscosity to be injection molded as desired in the present disclosure. The alkenyl terminated polyisobutylene/silicone hydride addition rubbers also have a viscosity as prepared that is too high. Their viscosity can be reduced through addition of plasticizers; however these sealants suffer from leaching of the plasticizer into the fuel cells which makes them unusable in the present disclosure. Polyisobutylene, a polyolefin hydrocarbon, is a synthetic form of rubber which has good mechanical properties and is moisture and gas impermeable. Being gas and moisture impermeable in addition to good mechanical properties is highly desirable for heat curable elastomer compositions in fuel cell applications.

It is desirable to provide a heat curable elastomeric composition that has low initial viscosity, rapid cure rate at relatively low temperatures and improved storage stability. Cured reaction products of this curable composition should have low compression set, low oxygen permeability and low moisture permeability.

### SUMMARY OF THE INVENTION

In general terms, this disclosure provides a heat curable elastomeric composition that has a low viscosity, low compression set, a rapid cure rate at relatively low temperatures, low oxygen permeability, low moisture permeability, long storage time in the uncured state and usefulness in closed injection molds. The disclosed elastomeric composition are not radiation curable and will not cure when exposed to ultraviolet or visible wavelength radiation.

In one embodiment the present invention is an injection moldable elastomeric composition for a sealant consisting essentially of: a) at least one (meth)acrylate terminated polyolefin polymer present in an amount of from 40 to 70 weight % based on the total weight of the elastomeric composition; b) at least one ester (meth)acrylate monomer comprising a C₁ to C₃₀ ester present in an amount of from 10 to 50 weight % based on the total weight of the elastomeric composition; c) at least one peroxide based heat curable free radical initiator present in an amount of from 0.3 to 3.0 weight % based on the total weight of the elastomeric composition; d) at least one silica filler present in an amount of from 2 to 30 weight % based on the total weight of the elastomeric composition; and e) optionally, one or more additives selected from the group consisting of antioxidants, stabilizers, pigments, photoinitiators, or mixtures thereof present in an amount of from 0.5 to 5 weight % based on the total weight of the elastomeric composition.

In another embodiment the present invention is an injection molded and heat cured elastomeric sealant consisting essentially of: a) at least one (meth)acrylate terminated polyolefin polymer present in an amount of from 40 to 70 weight % based on the total weight of the elastomeric composition; b) at least one ester (meth)acrylate monomer comprising a C₁ to C₃₀ ester present in an amount of from 10 to 50 weight % based on the total weight of the elastomeric composition; c) at least one peroxide based heat curable free radical initiator present in an amount of from 0.3 to 3.0 weight % based on the total weight of the elastomeric composition; d) at least one silica filler present in an amount of from 2 to 30 weight % based on the total weight of the elastomeric composition; and e) optionally, one or more additives selected from the group consisting of antioxidants, stabilizers, pigments, photoinitiators, or mixtures thereof present in an amount of from 0.5 to 5 weight % based on the total weight of the elastomeric composition.

These and other features and advantages of this disclosure will become more apparent to those skilled in the art from the detailed description of a preferred embodiment. The drawings that accompany the detailed description are described below.

### BRIEF DESCRIPTION OF THE DRAWINGS

FIG. 1 is a rheometer graph showing the cure kinetics of three elastomeric compositions according to the present disclosure.

FIG. 2 is a rheometer graph showing the cure kinetics of a fourth elastomeric composition according to the present disclosure.

### DETAILED DESCRIPTION OF A PREFERRED EMBODIMENT

In the present specification and claims the following terms have these definitions unless otherwise noted. The term (meth)acrylate refers to both acrylates and methacrylates, likewise the term (meth)acryloyl group is deemed to refer to both methacryloyl and acryloyl groups. Unless otherwise specified the term molecular weight refers to number average molecular weight.

The present disclosure is directed toward a heat curable elastomeric compositions for use in injection molded sealant applications for fuel cell environments. The composition preferably comprises: at least one polymer having a polyolefin backbone with terminations of (meth)acrylate functional groups; at least one (meth)acrylate monomer; at least one heat cure initiator, preferably peroxide-based free radical generator heat cure initiators; a filler; and additives including antioxidants, stabilizers, pigments, and optionally a photoinitiator. Especially preferred polymer backbones comprise polyisobutylene; butyl rubber; and hydrogenated or non-hydrogenated polybutadiene backbones. The elastomeric composition can be provided as a two component composition with the heat cure initiator provided in one of the components. The two components are stored separately and only mixed at time of use. In another embodiment the elastomeric composition can be provided as a one component mixture wherein all of the components are mixed together and the composition is stored and used in the mixed state.

The polymer having a polyolefin backbone with terminations of (meth)acrylate functional groups according to the present invention preferably comprises a polyisobutylene backbone with terminal (meth)acrylate groups at each end. Methods for preparation of such (meth)acrylate terminated polymers are known to those of skill in the art and they are also available commercially. Preferably the polymer backbone has a number average molecular weight of from 2,000 to 800,000, more preferably from 5,000 to 40,000. The polymer is preferably present in the elastomeric composition at a level of from 30 to 80 weight %, more preferably from 40 to 70 weight % based on the total weight of the elastomeric composition.

The elastomeric composition also preferably includes at least one (meth)acrylate monomer to aid in crosslinking and heat curing or a mixture of such monomers. Preferably these monomer(s) are selected from C₁ to C₃₀ ester (meth)acrylates and can include acyclic and/or cyclic (meth)acrylates such as, respectively, isobutyl acrylate, isooctyl acrylate, isodecyl acrylate, lauryl acrylate and isobornyl acrylate. The C₁ to C₃₀ refers to the size of the ester portion of the ester (meth)acrylate. Preferably the elastomeric composition comprises from 10 to 50 weight %, more preferably from 20 to 40 weight % of the at least one (meth)acrylate monomer or mixture of monomers based on the total weight of the elastomeric composition.

The heat-cure initiator or initiator system comprises an ingredient or a combination of ingredients which at the desired elevated temperature conditions produce free radicals. The reactivity of heat cure initiator is frequently measured by the half-life of the initiator, which expresses the time required to decompose the initiator to half of its original concentration at a specific temperature. Generally the lower half-life means higher reactivity, but a lower half-life is an indicator of a lower shelf-life stability for the uncured composition in which it is used. For example, t-butylperoxybenzoate has a 10 hour half-life temperature of 103° C. 1,1 bis(tert-amylperoxy)cyclohexane has a 10 hour half-life temperature of 93° C. Benzoyl peroxide has a 10 hour half-life temperature of 70° C. The preferred heat curing temperature is above 100° C.

Suitable initiators may include peroxy materials, e.g., peroxides, hydroperoxides, and peresters, which under appropriate elevated temperature conditions decompose to form peroxy free radicals which are effective for initiating the polymerization of the curable elastomeric sealant compositions. The heat cure initiators finding use in the present invention preferably comprise peroxide type initiators such as, by way of example only, t-butylperoxybenzoate, benzoyl peroxide, and 1,1 bis-(tert-amylperoxy) cyclohexane. The heat cure initiators may be employed in concentrations effective to initiate curing of the curable elastomeric sealant composition at a desired temperature and typically in concentrations of about 0.1% to about 10% by weight of composition; preferably about 0.3 to 3 weight % and more preferably about 0.5 to 1.5 weight % based on the total weight of the elastomeric composition.

Another useful class of heat-curing initiators comprises azonitrile compounds which yield free radicals when decomposed by heat. Heat is applied to the curable composition and the resulting free radicals initiate polymerization of the curable composition. Compounds of the above formula are more fully described in U.S. Pat. No. 4,416,921, the disclosure of which is incorporated herein by reference. Azonitrile initiators of the above-described formula are readily commercially available, e.g., the initiators which are commercially available under the trademark VAZO from E.I. DuPont de Nemours and Company, Inc., Wilmington, Del.

Generally a lower heat cure initiator half-life means results in a lower shelf-life stability, e.g. in premature curing of the curable composition during storage. Shelf-life stability of the composition can be improved by the addition of free radical inhibitors. Dihydroxybenzene such as hydroquinone, t-butylhydroquinone, butylated hydroxyl toluene, are effective inhibitors. Inhibitors can be used at concentration levels from 0.01 to 0.5 weight %, more preferably from 0.05 to 0.1 weight % based on the total weight of the elastomeric composition.

The composition optionally comprises a photoinitiator in addition to a heat cure initiator. The photoinitiator, when exposed to actinic radiation such as ultraviolet radiation, produces free radicals to drive a crosslinking or curing reaction. Use of both a heat cure initiator and a photoinitiator provides a composition having dual curing mechanisms. Suitable photoinitiators are known in the art. Examples of some useful photoinitiators include, but are not limited to, photoinitiators available commercially from Ciba Specialty Chemicals, under the “IRGACURE” and “DAROCUR” trade names. Combinations of these materials may also be employed herein.

The curable elastomeric sealant composition can optionally include a filler. Some useful fillers include, for example, lithopone, zirconium silicate, hydroxides, such as hydroxides of calcium, aluminum, magnesium, iron and the like, diatomaceous earth, carbonates, such as sodium, potassium, calcium, and magnesium carbonates, oxides, such as zinc, magnesium, chromic, cerium, zirconium and aluminum oxides, calcium clay, fumed silicas, silicas that have been surface treated with a silane or silazane such as the AEROSIL products available from Evonik Industries, silicas that have been surface treated with an acrylate or methacrylate such as AEROSIL R7200 or R711 available from Evonik Industries, precipitated silicas, untreated silicas, graphite, synthetic fibers and mixtures thereof. Preferably the composition comprises about 2 to about 30 weight %, more preferably about 5 to about 20 weight % based on the total weight of the elastomeric composition.

One preferred filler is silica filler that has been surface treated with a (meth)acrylate silane. Many such treated silica fillers are commercially available including from Wacker Chemie, Evonik, and others. One especially preferred filler is the (meth)acrylate silane treated silica HDK H30RY available from Wacker Chemie.

The present elastomeric composition can optionally include a variety of additives including antioxidants, stabilizers and pigments as are known in the art. Preferably when used these additives comprise 0.5 to 5 weight % based on the total weight of the elastomeric composition.

The present disclosure provides an elastomeric composition that finds special use as a sealing material and especially in the formation of elastomeric gaskets, such as those used in electronics, powertrains and many other automotive applications. These elastomeric gaskets are especially useful in fuel cell sealing applications. Fuel cells require many thin gaskets to allow for formation of the large stacks of sealed cells required for efficient utilization. Desirable properties for fuel cell gaskets are: a low compression set; low viscosity; high values for tensile strength, modulus and elongation; and low permeability to gas and moisture as described herein. Preferably, cured reaction products of the disclosed composition are elastomeric with a tensile strength greater than 3 Mpa, a modulus at 100% of from 0.5 to 2 Mpa, an elongation at break of more than 200% and a compression set after 24 hours at 125° C. of less than 20%. Preferably, the disclosed composition has an uncured viscosity of 20 to 1000 Pa·s and more preferably from 20 to 200 Pa·s to allow the composition to be injection molded into a mold for heat curing in the absence of light. Preferably, cured reaction products of the disclosed composition have a low permeability to gas and moisture that is 20% lower than the permeability to gas and moisture of cured reaction products of a conventional silicone rubber gasket material.

### Testing Methods

The following methods were used for testing of the cured and uncured elastomeric compositions in the present disclosure.

The viscosity of uncured elastomer samples was measured using a Haake, 150 RheoStress at 25° C. at 12 sec⁻¹ shear rate.

Shore A hardness was measured using the method of ASTM D2240-05.

The tensile strength, modulus and elongation at break were measured using the method of ASTM D412-98A.

The compression set was measured using the method of ASTM D395 at 125° C. for 24 hours, the samples were allowed to cool to room temperature before being removed.

The heat cure kinetics were tested using a RHEOPLUS/32 V3.61 21002166-33025 in the plate-plate mode of measurement. The settings were: normal force: 0 N; amplitude gamma=0.25%; angular frequency omega=10 1/s; gap 1 millimeter; temperature ramp from 25 to 130 C or 140° C. at 45° C./minute with a hold at 130 C or 140° C. The results are shown in a rheometer graph and in tabular form. In the table of results the kickoff temperature is the temperature at which the torque value begins to increase. The time T₀ is the time when the temperature reaches the curing temperature or the kicking off temperature, whichever comes first, T₁₀ is the time when the torque value reaches 10% of its maximum, and T₉₀ is the time when the torque value reaches 90% of its maximum torque. The injection time is represented by (T₁₀−T₀) and the cure time is represented by (T₉₀−T₀).

Examples 1-4 are a series of elastomeric compositions according to the present invention that were prepared and their cure kinetics and physical characteristics were determined and are recorded in the tables below. The polyisobutylene diacrylate used had a number average molecular weight of 12,000. Table 1 below lists the elastomeric compositions.

The polymer and monomers, stabilizer and fillers were mixed first at 50° C. The mixture was then cooled to room temperature. Finally heat initiator(s) was added and mixed into the composition. Solid heat initiators were first dissolved in isobornyl acrylate and the mixture was added in the last step. The elastomeric compositions were then cured at 130° C. for 1 hour between two Teflon molds with a thickness of 1 millimeter under a pressure of 200 psi. The cured elastomeric compositions were then tested for Shore A hardness, tensile strength, modulus at 100% elongation, elongation at break, and compression set using the methods described herein. In addition, 300 milliliter samples of each uncured elastomeric composition were stored at 38° C. or 50° C. and monitored weekly for undesirable formation of gelling which will determine storage stability.

TABLE 1
Compositions

| | | | | Ex- |
|---|---|---|---|---|
| | Example 1 | Example 2 | Example 3 | ample 4 |
| Component | Wt % | Wt % | Wt % | Wt % |
| Polyisobutylene diacrylate | 60 | 60 | 60 | 60.5 |
| Polybutyl diacrylate | 0 | 0 | 0 | 0 |
| Isobornyl acrylate | 18 | 18 | 18 | 18 |
| Isooctyl acrylate | 10 | 10 | 10 | 10 |
| Pentaerythritol tetrakis(3- | 1 | 1 | 1 | 1 |
| (3,5-di-tert-butyl-4- | | | | |
| hydroxyphenyl)propionate) | | | | |
| Stabilizer | | | | |
| t-butylperoxybenzoate | 1 | 0 | 0 | 0 |
| heat cure initiator | | | | |
| 1,1 bis(tert- | 0 | 1 | 0 | 1 |
| amylperoxy)cyclohexane | | | | |
| heat cure initiator | | | | |
| Benzoyl peroxide | 0 | 0 | 1 | .5 |
| heat cure initiator | | | | |
| Methacrylate silane | 10 | 10 | 10 | 9 |
| treated silica filler (HDK | | | | |
| H30RY) | | | | |
| Total | 100 | 100 | 100 | 100 |

TABLE 2
Composition Physical Properties

| Test | Example 1 | Example 2 | Example 3 | Example 4 |
|---|---|---|---|---|
| Uncured viscosity at | 123 | 131 | 127 | 98 |
| 25° C., 12 sec⁻¹ (Pa · s) | | | | |
| Cured Shore A hardness | 40 | 41 | 44 | 41 |
| Cured Tensile | 4.58 | 5.11 | 5.85 | 4.1 |
| strength (MPa) | | | | |
| Cured Modulus 100% | 0.92 | 1.14 | 1.54 | 1.17 |
| elongation (MPa) | | | | |
| Cured Elongation at | 362 | 310 | 267 | 267 |
| break (%) | | | | |
| Cured Compression | 13 | 10 | 10 | 9 |
| set (%) | | | | |

The results presented in Table 2 show that all of the Example formulations have the desirable physical characteristics such as a tensile strength greater than 4 Mpa, a modulus at 100% greater than 0.9 Mpa, elongation at break greater than 200% and compression set less than 20%. The uncured compositions all have an uncured viscosity of less than 200 Pa·s, sufficiently low enough to make them easy to use in injection molding operations and not too low to cause bubbles that will be trapped in the composition during the molding operation. The cured elastomeric reaction products all have sufficiently robust physical characteristics of Shore A hardness, tensile strength, modulus, elongation at break and compression set for use in the environment of fuel cell sealing.

TABLE 3
Composition heat cure properties

| | | | | Example | Example |
|---|---|---|---|---|---|
| Test | Example 1 | Example 2 | Example 3 | 4¹ | 4² |
| Kick off | 139 | 139 | 137 | 127 | 138 |
| temperature | | | | | |
| ° C. | | | | | |
| T₀ (minutes) | 2.68 | 2.68 | 2.29 | 2.29 | 2.58 |
| T₁₀ | 4.20 | 3.75 | 2.82 | 3.15 | 3.11 |
| (minutes) | | | | | |
| T₉₀ | 6.72 | 5.23 | 3.87 | 4.8 | 4.24 |
| (minutes) | | | | | |
| Injection | 91 | 64 | 32 | 52 | 32 |
| time | | | | | |
| (seconds) | | | | | |
| Cure time | 242 | 153 | 95 | 151 | 100 |
| (seconds) | | | | | |

¹Example 4 heat cured at 130° C.
²Example 4 heat cured at 140° C.

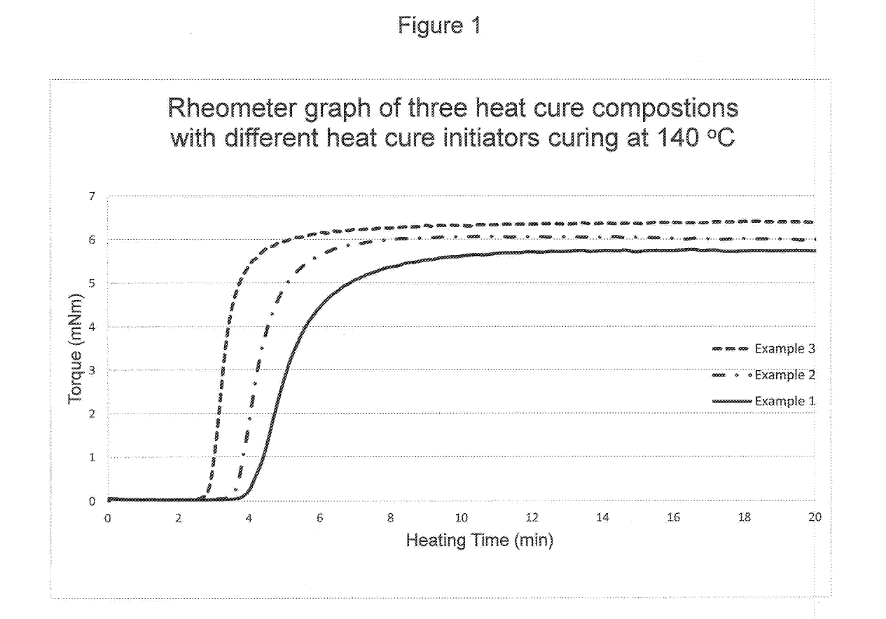

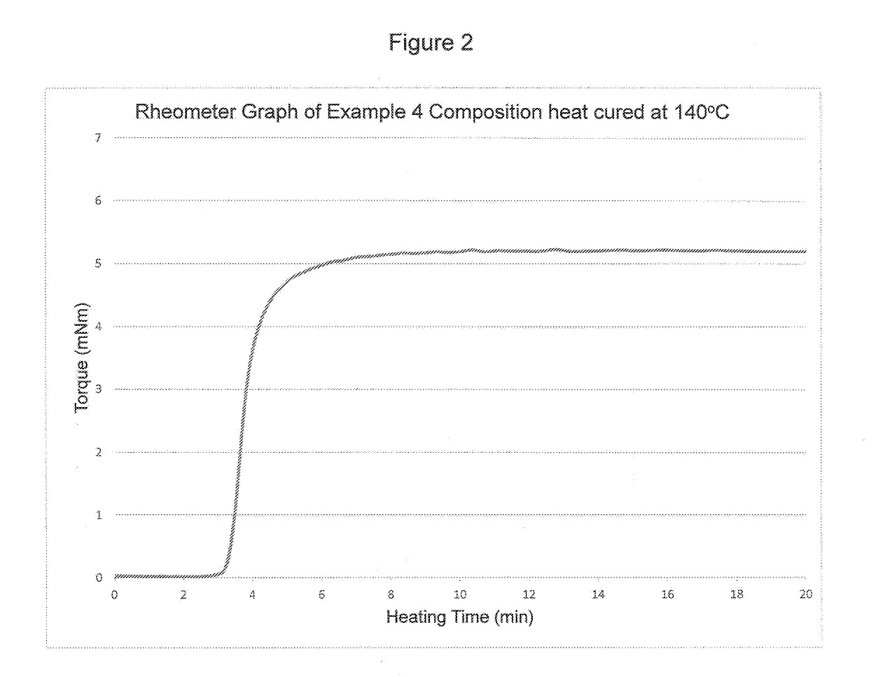

FIG. 1 is the rheometer graph of the Examples 1, 2 and 3 compositions curing at 140° C. FIG. 2 is the rheometer graph of the Example 4 composition curing at 140° C. The data in Table 3 is from Examples 1-4 cured at 130° C. or 140° C. The data shows that the disclosed elastomeric compositions have different curing characteristics due to the different initiator reactivity indicated by its 10 hr. half-life temperature. The data indicates that the disclosed elastomeric compositions have an injection time (30-90 seconds) sufficiently long enough to allow for complete filling of an injection mold while the cure time (100-250 seconds) is sufficiently short enough to allow for mass production of the seals.

TABLE 4
Composition Storage stability

| Test | Example 1 | Example 2 | Example 3 | Example 4 |
|---|---|---|---|---|
| Gel formation at 38° C. | >6 weeks | >6 weeks | 2-3 weeks | 8 weeks |
| (weeks) | | | | |
| Gel formation at 50° C. | 1-2 weeks | >6 weeks | <1 week | <1 week |
| (weeks) | | | | |

The data in Table 4 shows that the cure initiator can have a significant effect on the storage stability of the elastomeric composition. The most stable single initiator compositions were those using the heat cure initiator 1,1 bis(tert-amylperoxy) cyclohexane.

It is desirable to have one component heat curable compositions with fast heat cure time and with long storage stability. Example 4 is a composition with two heat cure initiators: 1,1 bis(tert-amylperoxy)cyclohexane and benzoyl peroxide. FIG. 2 is the rheometer graph of the Example 4 composition curing at 140° C. The physical data for Example 4 in Table 2 is from samples of Example 4 cured at 140° C. Table 3 illustrates that the Example 4 composition has a similar injection time and curing time as Example 3. However, Table 4 illustrates that the Example 4 composition shows a surprising improvement of storage stability for the uncured composition.

DSC is a good method to measure the minimum curing temperature for injection molding. Differential Scanning calorimeter (DSC) was used to measure the temperature at which the uncured composition starts to polymerize and when the composition is fully polymerized. Onset temperature is the temperature the material starts polymerization, and the peak temperature is the temperature at which the heat flow or heat capacity reaches maximum. The ΔH value recorded at the transition is the enthalpy of the polymerization reaction, indicating the heat released after the material is fully cured. Table 5 is the summary of the onset temperature, peak temperature and ΔH value of the example compositions.

TABLE 5

| | Example 1 | Example 3 | Example 4 |
|---|---|---|---|
| Onset temperature (° C.) | 131 | 107 | 113 |
| Peak temperature (° C.) | 138 | 112 | 119 |
| ΔH (J/g) | −103 | −128 | −106 |

Oxygen permeability was tested using a Mocon Oxtran 2/60 with 100% O₂ at room temperature and 0% relative humidity. The moisture transmission rate was measured using 1 mm thick cured elastomer or silicone rubber films on a Mocon Permatran W with 100% humidity at 40° C. Example 3 was compared to a commercial silicone rubber gasket material for oxygen permeability and moisture transmission. As shown Table 6, the cured example 3 composition has a much lower oxygen permeability and much lower moisture transmission rate than conventional silicone robber gasket materials. All of the disclosed compositions are believed to have these low oxygen permeability and low moisture transmission rate.

TABLE 6

| | | Commercial silicone |
|---|---|---|
| Parameter | Example 3 | rubber gasket material |
| Oxygen permeability (cc- | 242 | 9,975 |
| mil/100 in²/day) | | |
| Moisture transmission | 11 | 130 |
| rate (g/m²/day) | | |

As known to those of skill in the art the presently disclosed elastomeric sealant can be used in a variety of injection molding processes. In one process the mold can be used to create a sealant having a specific shape. In such a process the mold serves to form the final shape of the sealant. In another process a part of a fuel cell can be held in an appropriate orientation and the sealant can be injection molded onto a surface of the fuel cell part. In another embodiment two or more parts of a fuel cell can be held in appropriate orientation to each other and the elastomeric composition can be injected between the parts to form seal between the parts.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A heat curable composition for providing a cured elastomeric seal, consisting essentially of:
a) at least one (meth)acrylate terminated polyolefin polymer selected from the group consisting of (meth)acrylate terminated polyisobutylene, (meth)acrylate terminated butyl rubber, (meth)acrylate terminated hydrogenated polybutadiene, (meth)acrylate terminated non-hydrogenated polybutadiene and present in an amount of from 40 to 70 weight % based on the total weight of the elastomeric composition;
b) at least one ester (meth)acrylate monomer comprising a C₁ to C₃₀ ester present in an amount of from 10 to 50 weight % based on the total weight of the elastomeric composition;
c) at least one free radical heat cure initiator present in an amount of from 0.3 to 3.0 weight % based on the total weight of the elastomeric composition;
d) at least one silica filler present in an amount of from 2 to 30 weight % based on the total weight of the elastomeric composition; and
e) optionally, one or more additives selected from the group consisting of antioxidants, stabilizers, pigments, photoinitiators or mixtures thereof present in an amount of from 0 to 5 weight % based on the total weight of the composition.

2. The heat curable composition as recited in claim 1 wherein said at least one (meth)acrylate terminated polyolefin polymer is present in an amount of from 50 to 60 weight % based on the total weight of the composition.

3. The heat curable composition as recited in claim 1 wherein said at least one (meth)acrylate terminated polyolefin polymer has a number average molecular weight of from 5000 to 40,000.

4. The heat curable composition as recited in claim 1 wherein said at least one ester (meth)acrylate monomer is present in an amount of from 20 to 40 weight % based on the total weight of the composition.

5. The heat curable composition as recited in claim 1 wherein said at least one free radical heat cure initiator is present in an amount of from 0.5 to 1.5 weight % based on the total weight of the composition.

6. The heat curable composition as recited in claim 1 wherein said at least one free radical heat cure initiator is selected from a combination of benzoyl peroxide and 1,1 bis(tert-amylperoxy) cyclohexane.

7. The heat curable composition as recited in claim 1 wherein said at least one silica filler has been surface modified by treatment with a (meth)acrylate silane.

8. The heat curable composition as recited in claim 1 wherein the one or more additives are present in an amount of from 0.5 to 5 weight % based on the total weight of the elastomeric composition.

9. The heat curable composition as recited in claim 1 wherein said composition has an uncured viscosity of from 20 Pa·s to 1,000 at 25° C. 12 sec⁻¹.

10. The heat curable composition as recited in claim 1 wherein said composition has a cure time of from 95 to 242 seconds at a temperature of 140° C.

11. The heat curable composition as recited in claim 1 wherein said composition has an injection time of from 32 to 91 seconds at a temperature of 140° C.

12. Cured reaction products of the heat curable elastomeric composition of claim 1.

13. Cured reaction products of the heat curable elastomeric composition of claim 1 having a tensile strength greater than 3 MPa

14. Cured reaction products of the heat curable elastomeric composition of claim 1 having a modulus at 100% of from 0.5 to 2 Mpa.

15. Cured reaction products of the heat curable elastomeric composition of claim 1 having an elongation at break above 200%

16. Cured reaction products of the heat curable elastomeric composition of claim 1 having a compression set after 24 hours at 125° C. of less than 20%.

17. The heat curable composition as recited in claim 1 wherein said at least one (meth)acrylate terminated polyolefin polymer is a di(meth)acrylate polyisobutylene polymer.

18. The heat curable composition as recited in claim 1 including both at least one free radical heat cure initiator and at least one free radical photoinitiator.

19. Cured reaction products of the heat curable composition as recited in claim 1.

20. An article comprising cured reaction products of the heat curable composition as recited in claim 1.
